(19) United States
(12) Patent Application Publication
(10) Pub. No.: US 2011/0197811 A1
(43) Pub. Date: Aug. 18, 2011

(54) DEVICE FOR INTRODUCING CATALYST INTO ATOMIZED COATING COMPOSITION

(75) Inventors: John Charles Larson, West Chester, PA (US); Laura Ann Lewin, Greenville, DE (US); Robert John Barsotti, Franklinville, NJ (US)

(73) Assignee: E.I. DU PONT DE NEMOURS AND COMPANY, Wilmington, DE (US)

(21) Appl. No.: 13/125,063

(22) PCT Filed: Dec. 23, 2008
(86) PCT No.: PCT/US08/88088

§ 371 Date: Apr. 20, 2011

Related U.S. Application Data
(62) Division of application No. 61/110,173, filed on Oct. 31, 2008.

(51) Int. Cl. B05C 11/06; B05B 7/04

(52) U.S. Cl. 118/695; 239/398

(57) ABSTRACT

The present invention is directed to a delivery device and a system for introducing a second component into an atomized composition. The present invention is particularly directed to a delivery device and a system for introducing a catalyst into an atomized coating composition.

### FIELD OF INVENTION

The present invention is directed to a delivery device and a system for introducing a second component into an atomized composition. The present invention is particularly directed to a delivery device and a system for introducing a catalyst into an atomized coating composition.

### BACKGROUND OF INVENTION

Automobile coatings typically comprise crosslinked polymer network formed by multiple reactive components. The coatings are typically sprayed onto a substrate such as automobile vehicle body or body parts using a spray device and then cured to form a coating layer having such crosslinked polymer network.

In spray technologies currently used in refinish shops, multiple reactive components of a coating composition are mixed to form a pot mix prior to spraying and placed in a cup-like reservoir or container that is attached to a spraying device such as a spray gun. Due to the reactive nature of the multiple reactive components, the pot mix will start to react as soon as they are mixed together causing continued increase in viscosity of the pot mix. Once the viscosity reaches a certain point, the pot mix becomes practically un-sprayable. The possibility that the spray gun itself may become clogged with crosslinked polymer materials is also disadvantageous. The time it takes for the viscosity to increase to such point where spraying becomes ineffective, generally up to a two-fold increase in viscosity, is referred to as “pot life”.

One way to extend “pot life” is to add a greater amount of thinning solvent, also known as thinning agent, to the pot mix. However, thinning agent, such as organic solvent, contributes to increased emissions of volatile organic compounds (VOC) and also increases the curing time.

Other attempts to extend “pot life” of a pot mix of a coating composition have focused on “chemical-based” solutions. For example, it has been suggested to include modifications of one or more of the reactive components or certain additives that would retard polymerization reaction of the multiple components in the pot mix. The modifications or additives must be such that the rate of curing is not adversely affected after the coating is applied to the surface of a substrate.

Another approach is to mix one or more key components, such as a catalyst, together with other components of the coating composition immediately prior to spraying. One example is described in U.S. Pat. No. 7,201,289 in that a catalyst solution is stored in a separate dispenser and being dispensed and mixed with a liquid coating formulation before the coating formulation is atomized.

Yet another approach is to separately atomize two components, such as a catalyst and a resin, of a coating composition, and mix the two atomized components after spray. One such example is described in U.S. Pat. No. 4,824,017. However, such approach requires atomization of two components separately by using separate pumps and injection means for each of the two components.

### STATEMENT OF INVENTION

This invention is directed to a system for producing a layer of a coating composition on a substrate, said coating composition comprises two or more coating components, said system comprising:
(A) a spray gun comprising a spray gun body (1), one or more inlets, a nozzle assembly (2) including an orifice (13) and an air cap (24); and
(B) a delivery device comprising:
   (i) at least one delivery outlet (14), wherein said delivery outlet being transversely positioned at said orifice (13);
   (ii) at least one intake coupling (8); and
   (iii) at least one connection path (11) connecting said intake coupling (8) and said delivery outlet (14), wherein said delivery outlet is coupled through said connection path (11) and said intake coupling (8) to a second storage container (4) containing a second coating component;
(C) optionally, a regulatory device (32) coupled to said delivery outlet regulating the supply of the second coating component to said delivery outlet;
wherein a first atomized stream of a first coating component of said coating composition is produced at said orifice (13) with a stream of a pressurized carrier, wherein said first coating component is stored in a first storage container (3) and conveyed through a first inlet of said spray gun to said orifice (13);
wherein a second atomized stream of the second coating component of said coating composition is produced by siphoning the second coating component with a siphoning stream selected from the first atomized stream of the first coating component, the stream of the pressurized carrier, or a combination thereof, from said delivery outlet (14) coupled to the second storage container (4) containing said second coating component.

This invention is also directed to a system for producing a mixed composition comprising two or more components, said system comprising:
(A) a spray device for producing a first atomized stream of a first component of said mixed composition through an orifice (13) of said spray device; and
(B) a delivery device comprising:
   (i) at least one delivery outlet, wherein said delivery outlet being transversely positioned at said orifice (13);
   (ii) at least one intake coupling (8); and
   (iii) at least one connection path (11) connecting said intake coupling (8) and said delivery outlet (14), wherein said delivery outlet is coupled through said connection path (11) and said intake coupling (8) to a second storage container (4) containing a second component;
(C) optionally, a regulatory device (32) coupled to said delivery outlet regulating the supply of the second component;
wherein a first atomized stream of a first component of said mixed composition is produced at said orifice (13) with a stream of a pressurized carrier, wherein said first component is stored in a first storage container (3) and conveyed through a first inlet of said spray gun to said orifice (13);
wherein a second atomized stream of the second component of said mixed composition is produced by siphoning the second component with a siphoning stream selected from the first atomized stream of the first component, the stream of the pressurized carrier, or a combination thereof, from said delivery outlet (14) coupled to the second storage container (4) containing said second component.

### BRIEF DESCRIPTION OF DRAWING

FIG. 1 shows a spray gun affixed with an example of a representative delivery device of this invention.

FIG. 2 shows frontal views of the delivery device viewed from the direction 2A indicated in FIG. 1. (A) A schematic presentation of a representative example of the delivery device 20 constructed as an add-on device. (B) A schematic presentation of a representative example of the delivery device 2′ having one delivery outlet constructed into the air cap of the spray gun. (C) A schematic presentation of a representative example of the delivery device 2″ having two delivery outlets constructed into the air cap of the spray gun. (D) A schematic presentation of a representative example of the delivery device 2′″ having three delivery outlets (14) constructed into the air cap of the spray gun.

FIG. 3 shows an enlarged frontal view, in a schematic presentation, of a representative example of the delivery device 20 constructed as an add-on device that can be affixed to an air cap of a spray gun. A single intake coupling (8) is shown.

FIG. 4 shows an enlarged frontal view, in a schematic presentation, of another representative example of the delivery device 2D′ constructed as an add-on device that can be affixed to an air cap of a spray gun. Two intake couplings (8) are shown.

FIG. 5 shows an enlarged frontal view of details of the delivery device and the relative position of the delivery device and the orifice of the spray gun. Two delivery outlets (14), two connection paths (11) and one orifice (13) are shown. The arrows 6 indicate the direction of a cross-sectional view used in FIGS. 6, 7 and 8.

FIG. 6 shows an enlarged side cross sectional view of details of one example of the delivery device and the relative position of the delivery device and the orifice of the spray gun. The orifice (13) can be positioned in three different regions indicated with a, b and c, respectively.

FIG. 7 shows schematic presentations of examples of the formation of a coating mixture. (A) An example of a first coating component that is atomized at an orifice of a spray gun without the introduction of a second coating component. (B) An example of the coating mixture formed by an atomized first coating component and an atomized second coating component.

FIG. 8 shows schematic presentations of another example of the formation of a coating mixture. (A) A first coating component atomized at an orifice of a spray gun without the introduction of a second coating component. (B) A coating mixture formed by an atomized first coating component and an atomized second coating component.

FIG. 9 shows additional examples of the delivery device of this invention constructed as an add-on device. (A) An example of the delivery device that has a configuration of two intake couplings (8) and two delivery outlets (14). (B) An example of the delivery device that has a configuration of two intake couplings (8) and one common delivery outlet (14). The orifice (13) is shown in the figure to indicate relative position of the delivery device when affixed to the air cap. The orifice (13) is part of the spray gun.

FIG. 10 shows schematic presentations of different configurations of the delivery device of this invention. (A) An example of a delivery device having one intake coupling that is coupled to one storage container, (B) An example of a delivery device having one intake coupling that is coupled to two individual storage containers. (C) An example of a delivery device having two intake couplings that are coupled to two storage containers. (D) An example of a delivery device having three intake couplings that all three of them are coupled to a single storage container. (E) An example of a delivery device having three intake couplings that one of them is coupled to an individual storage container while other two are coupled to a single container. (F) Another example of a delivery device having three intake couplings that only one of them is coupled to a single storage container. (G) Another example of a delivery device having three intake couplings that two of them are coupled to a single storage container. (H) Another example of a delivery device having three intake couplings that each of the first and the second is coupled to an individual storage container while the third is not coupled to any container. The schematic representations are for illustration purposes only and items in the presentations may not be to scale. The orifice (13) is part of the spray gun.

FIG. 11 shows an example of another representative configuration.

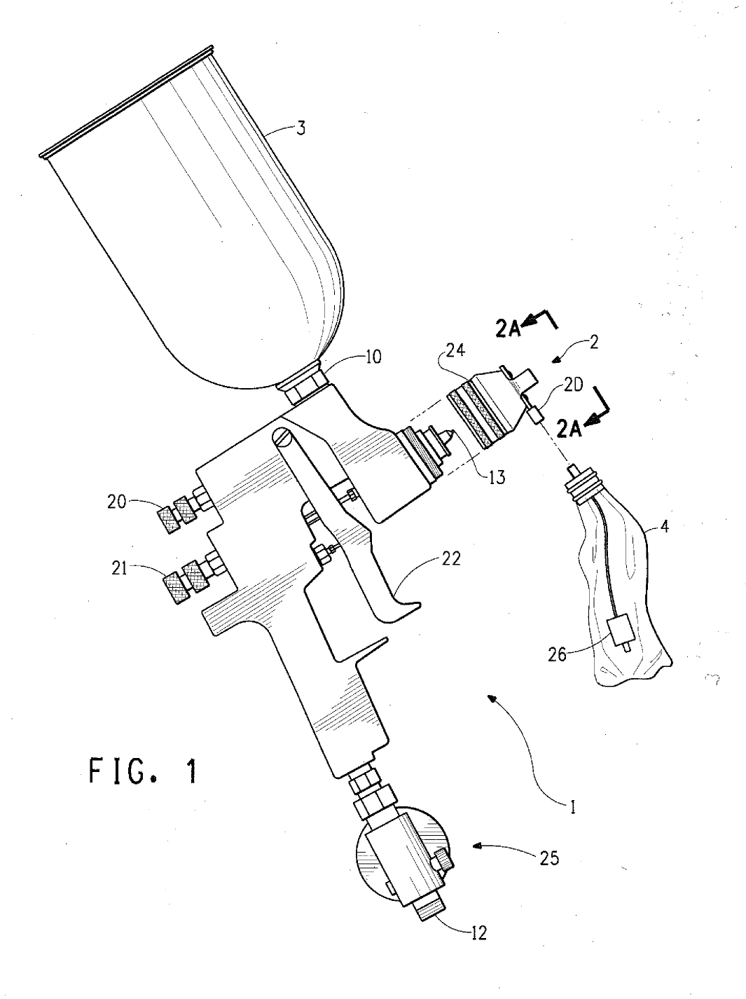

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about,” in this manner, slight variations above and below the stated ranges can be used to achieve substantially the same results as values within the ranges. Also, the disclosure of these ranges is intended as a continuous range including every value between the minimum and maximum values.

As used herein:

“Two-pack coating composition”, also known as 2K coating composition, means a thermoset coating composition comprising two components that are stored in separate containers, which are typically sealed for increasing the shelf life of the components of the coating composition. The components are mixed just prior to use to form a pot mix, which has a limited pot life, typically few minutes, such as 15 minutes to 45 minutes to few hours, such as 4 hours to 10 hours. The pot mix is applied as a layer of desired thickness on a substrate surface, such as the body or body parts of a vehicle. After application, the layer dries and cures to form a coating on the substrate surface having desired coating properties, such as, high gloss, mar-resistance, resistance to environmental etching and resistance to degradation by solvent. A typical two-pack coating composition comprises a crosslinkable component and a crosslinking component.

“One-Pack coating composition”, also known as 1K coating composition, means a coating composition comprises multiple ingredients mixed in one single package. A one-pack coating composition can form a coating layer under certain conditions. One example of 1K coating composition can comprise a blocked crosslinking agent that can be activated under certain conditions. One example of the blocked crosslinking agent can be a blocked isocyanate. Another example of 1K coating composition can be a UV radiation curable coating composition.

“Low VOC coating composition” means a coating composition that includes less than 0.6 kilograms per liter (5 pounds per gallon), preferably less than 0.52 kilograms (4.3 pounds per gallon), more preferably less than 0.42 kilograms (3.5 pounds per gallon) of volatile organic component, such as certain organic solvents. The phrase “volatile organic component” is herein referred to as VOC. VOC level is determined under the procedure provided in ASTM D3960.

“Crosslinkable component” includes a compound, oligomer, or polymer having crosslinkable functional groups positioned in each molecule of the compound, oligomer, the backbone of the polymer, pendant from the backbone of the polymer, terminally positioned on the backbone of the polymer, or a combination thereof. One of ordinary skill in the art would recognize that certain crosslinkable group combinations would be excluded from the crosslinkable component of the present invention, since, if present, these combinations would crosslink among themselves (self-crosslink), thereby destroying their ability to crosslink with the crosslinking groups in the crosslinking components defined below.

Typical crosslinkable component can have on an average 2 to 25, preferably 2 to 15, more preferably 2 to 10, even more preferably 3 to 7, crosslinkable groups selected from hydroxyl, thiol, acetoacetoxy, carboxyl, primary amine, secondary amine, epoxy, anhydride, imino, ketimine, aldimine, silane, or a combination thereof.

“Crosslinking component” is a component that includes a compound, oligomer, or polymer having crosslinking functional groups positioned in each molecule of the compound, oligomer, the backbone of the polymer, pendant from the backbone of the polymer, terminally positioned on the backbone of the polymer, or a combination thereof, wherein these functional groups are capable of crosslinking with the crosslinkable functional groups on the crosslinkable component (during the curing step) to produce a coating in the form of crosslinked structures. One of ordinary skill in the art would recognize that certain crosslinking group/crosslinkable group combinations would be excluded from the present invention, since they would fail to crosslink and produce the film forming crosslinked structures.

Typical crosslinking component can be selected from a compound, oligomer, polymer or copolymer having crosslinking functional groups selected from the group consisting of isocyanate, amine, ketimine, melamine, epoxy, carboxylic acid, anhydride, and a combination thereof. It would be clear to one of ordinary skill in the art that generally certain crosslinking groups from crosslinking components crosslink with certain crosslinkable groups from the crosslinkable components. Some of those paired combinations include: (1) ketimine crosslinking groups generally crosslink with acetoacetoxy, epoxy, or anhydride crosslinkable groups; (2) isocyanate and melamine crosslinking groups generally crosslink with hydroxyl, thiol, primary and secondary amine, ketimine, or aldimine crosslinkable groups; (3) epoxy crosslinking groups generally crosslink with carboxyl, primary and secondary amine, ketimine, or anhydride crosslinkable groups; (4) amine crosslinking groups generally crosslink with acetoacetoxy crosslinkable groups; (5) carboxylic acid crosslinking groups generally crosslink with epoxy crosslinkable groups; and (6) anhydride crosslinking groups generally crosslink with epoxy and ketimine crosslinkable groups.

A coating composition can further comprise a catalyst, an initiator, an activator, a curing agent, or a combination thereof.

A catalyst can initiate or promote the reaction between reactants, such as between crosslinkable functional groups of a crosslinkable component and crosslinking functional groups of a crosslinking component of a coating composition. The amount of the catalyst depends upon the reactivity of functional groups. Generally, in the range of from about 0.001 percent to about 5 percent, preferably in the range of from 0.01 percent to 2 percent, more preferably in the range of from 0.02 percent to 1 percent, all in weight percent based on the total weight of the crosslinkable component solids, of the catalyst is utilized. A wide variety of catalysts can be used, such as, tin compounds, including organotin compounds such as dibutyl tin dilaurate; or tertiary amines, such as, triethylenediamine. These catalysts can be used alone or in conjunction with carboxylic acids, such as, acetic acid. One example of commercially available catalysts is dibutyl tin dilaurate as Fascat® series sold by Arkema, Bristol, Pa., under respective trademark.

An activator can activate one or more components of a coating composition. For example, water can be an activator for a coating described in PCT publication WO2005/092934, published on Oct. 6, 2005, wherein water activates hydroxyl groups by hydrolyzing orthoformate groups that block the hydroxyl groups from reacting with crosslinking functional groups.

An initiator can initiate one or more reactions. Examples can include photo initiators and/or sensitizers that cause photopolymerization or curing of a radiation curable coating composition, such as a UV curable coating composition upon radiation, such as UV irradiation. Many photo initiators are known to those skilled in the art and can be suitable for this invention. Examples of photo initiators can include, but not limited to, benzophenone, benzoin, benzoinmethyl ether, benzoin-n-butyl ether, benzoin-iso-butyl ether, propiophenone, acetophenone, 1-hydroxycyclohexyl phenyl ketone, 2,2-diethoxyacetophenone, ethylphenylpyloxylate, diphenyl(2,4,6-trimethylbenzoyl)-phosphine oxide, phosphine oxide, phenyl bis(2,4,6-trimethyl benzoyl), phenanthraquinone, and a combination thereof. Other commercial photo initiator products, or a combination thereof, such as Darocure® 1173, Darocure® MBF, Darocure® TPO or Irgacure® 184, Irgacure® 4265, Irgacure® 819, Irgacure® 2022 or Irgacure® 2100 from Ciba Co., can also be suitable. Darocure® and Irgacure® are registered trademarks of Ciba Specialty Chemicals Corporation, New York.

A curing agent can react with other components of a coating composition to cure the coating composition into a coating. For example, a crosslinking component, such as isocyanate, can be a curing agent for a coating comprising a crosslinkable hydroxyl component. On the other hand, a crosslinkable component can be a curing agent for a crosslinking component.

In conventional coating practice, components of a two-pack coating composition are mixed immediately prior to spraying to form a pot mix which has a limited pot life, wherein said components can include a crosslinking component, a crosslinkable component, necessary catalysts, and other components necessary as determined by those skilled in the art. In addition to the limited pot life, many catalysts can change its activity in the pot mix. For example, some catalysts can be sensitive to the trace amount of water in the pot mix since water can cause hydrolysis and hence inactivation of the catalyst.

One prior approach is to mix the catalyst with other components of the coating composition immediately prior to spraying. One example is described in aforementioned U.S. Pat. No. 7,201,289 in that a catalyst solution is stored in a separate dispenser and being dispensed and mixed with a liquid coating formulation before the coating formulation is atomized. However, this approach requires mixing the catalyst and the liquid coating composition prior to atomization.

Another example of prior approach is described in U.S. Pat. No. 4,824,017 in that a catalyst and a resin of a coating composition are separately atomized and mixed after atomization. However, such approach requires atomization of two components separately by using separate pumps and individual injection means for each of the two components. This approach also requires intensive adjustment and monitoring of the individual atomization and injection to ensure constant mixing ratio of the two components.

This invention is directed to a method for producing a layer of a coating composition on a substrate using a spray gun. The coating composition can comprise two or more coating components. The method can comprise the following steps:
(A) producing a first atomized stream of a first coating component of said coating composition through an orifice of said spray gun with a stream of a pressurized carrier, wherein said first coating component is stored in a first storage container and conveyed through a first inlet of said spray gun to said orifice;
(B) producing a second atomized stream of a second coating component of said coating composition, wherein the second atomized stream is produced by siphoning the second coating component with a siphoning stream selected from the first atomized stream of the first coating component, the stream of the pressurized carrier, or a combination thereof, from at least one delivery outlet of a delivery device coupled to a second storage container containing said second component, said delivery outlet being transversely positioned at said orifice;
(C) optionally, regulating the supply of the second coating component to said delivery outlet by coupling a regulatory device to said delivery outlet;
(D) intermixing the first atomized stream and the second atomized stream to form a coating mixture; and
(E) applying the coating mixture on the substrate to form the layer of said coating composition thereon.

Any spray gun that can produce a stream of atomized coating composition can be suitable for this invention. A gravity feed spray gun is preferred. A gravity feed spray gun using a pressurized carrier as an atomization carrier is further preferred. The pressurized carrier can be selected from compressed air, compressed gas, compressed gas mixture, or a combination thereof. Typically, the pressurized carrier can be compressed air. Typically, a spray gun comprises a spray gun body (1), a nozzle assembly (2) including an orifice (13) and an air cap (24), a carrier coupling (12) for coupling to a source of a pressurized carrier, such as compressed air, an air regulator assembly (25) for regulating flow rate and pressure of the carrier, a coating flow regulator (21) for regulating the flow of the first coating omponent that is stored in a main reservoir also known as a first storage container (3), and a first inlet (10) coupling the spray gun (1) to the first storage container (3). The spray gun typically also includes additional controls such as a trigger (22) and a spray fan regulator (20) for regulating compressed air. In a typical gravity feed spray gun, the first coating component is typically not pressurized and stored in the first storage container (3) which is at atmosphere pressure. The first coating component can be conveyed to the orifice by gravity, siphoning, or a combination of gravity and siphoning.

The pressurized carrier can be selected from compressed air, compressed gas, compressed gas mixture, or a combination thereof. Typically, the pressurized carrier is compressed air. Compressed gas, such as compressed nitrogen, compressed carbon dioxide, compressed fluorocarbon, or a mixture thereof, can also be used. The compressed carrier can also include gases produced from compressed liquids, solids, or reactions from liquids or solids.

The coating composition can be a primer, a basecoat, a pigmented basecoat, or a clearcoat composition. The coating layer formed therefrom can be a primer layer, a basecoat layer, a pigmented basecoat layer, or a clearcoat layer, respectively.

In one example, the first coating component can be a pot mix comprises mixed crosslinkable and crosslinking components of a 2K coating composition without one or more materials selected from a catalyst, an initiator, an activator, or a combination thereof. The second coating component can comprise one or more materials selected from a catalyst, an initiator, an activator, or a combination thereof. In another example, the first coating component can comprise crosslinkable component of a 2K coating composition while the second coating component can be a crosslinking component of the coating composition plus one or more materials selected from a catalyst, an initiator, an activator, or a combination thereof. In this example, the crosslinking component can also be referred to as a curing agent. In yet another example, the first coating component can be a 1K UV curable coating composition without one or more materials selected from a photoinitiator, an activator, a catalyst, or a combination thereof, while the second coating component can comprise one or more materials selected from a photoinitiator, an activator, a catalyst, or a combination thereof, in yet another example, the first coating component comprises crosslinkable hydroxyl groups and orthoformate group blocked isocyanate groups. while the second coating component comprises one or more activators, such as an acid or water that can activate the first coating component comprising an acid or water activatable functional groups, such as aforementioned orthoformate group blocked isocyanate groups, to form a coating.

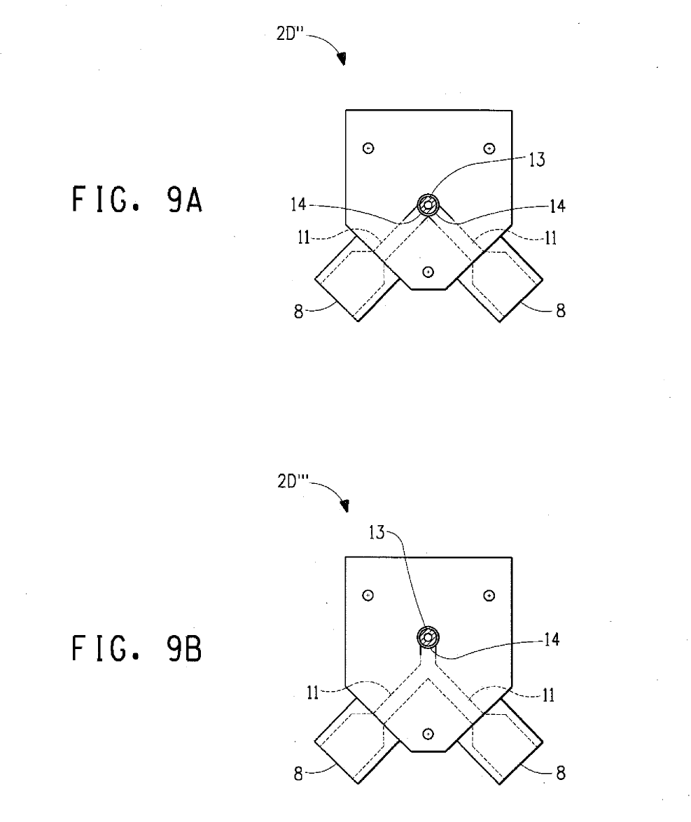

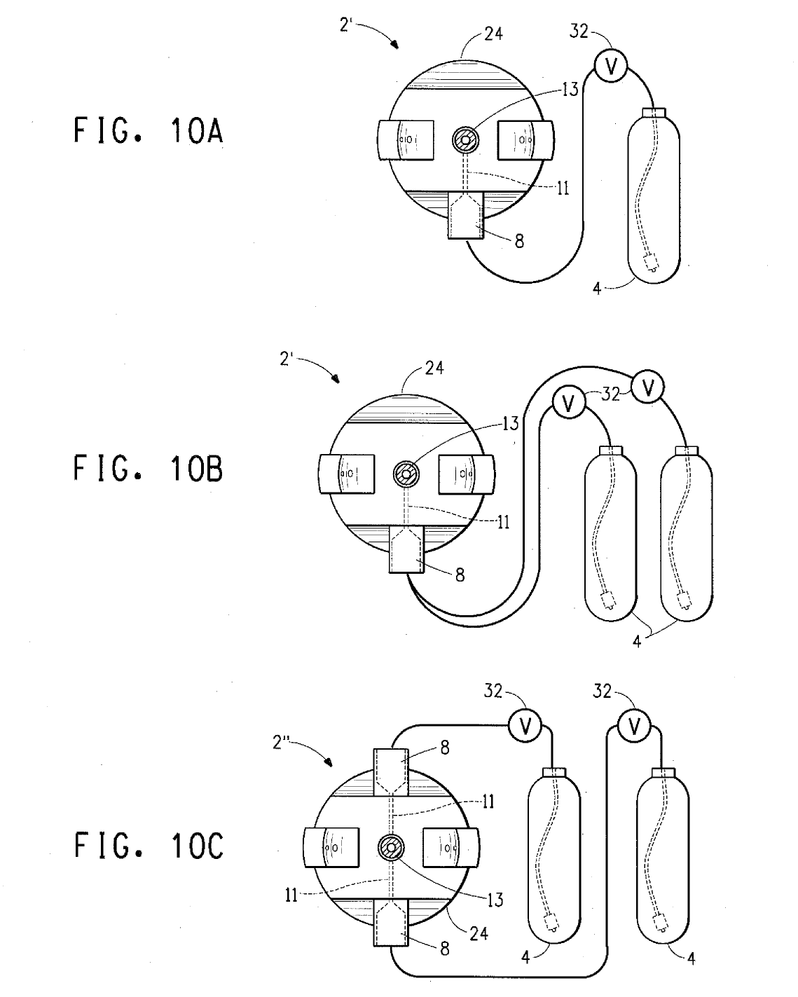

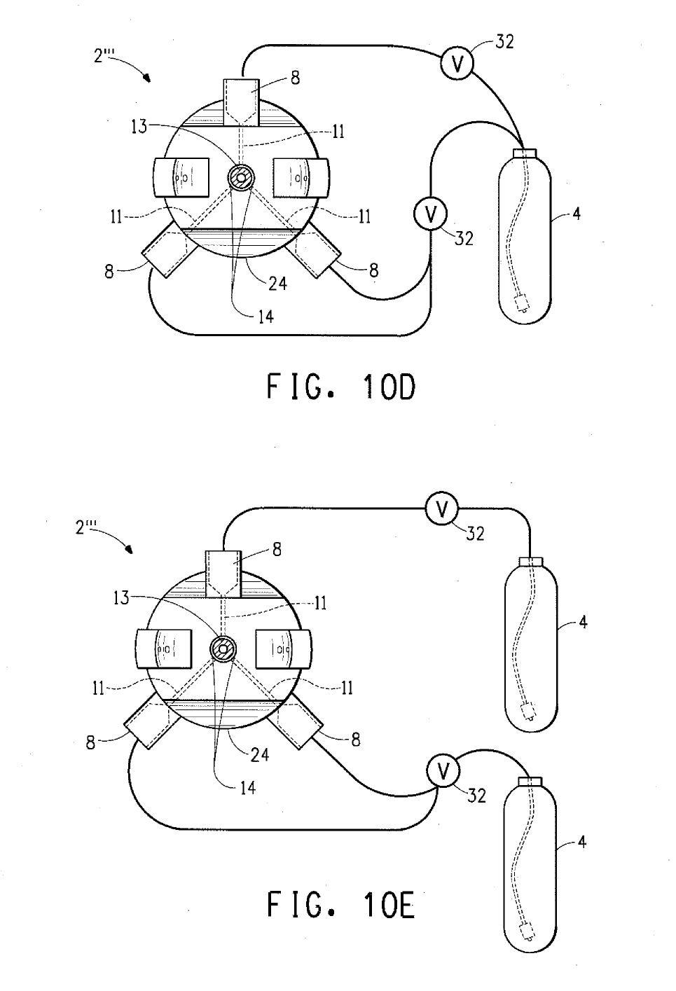

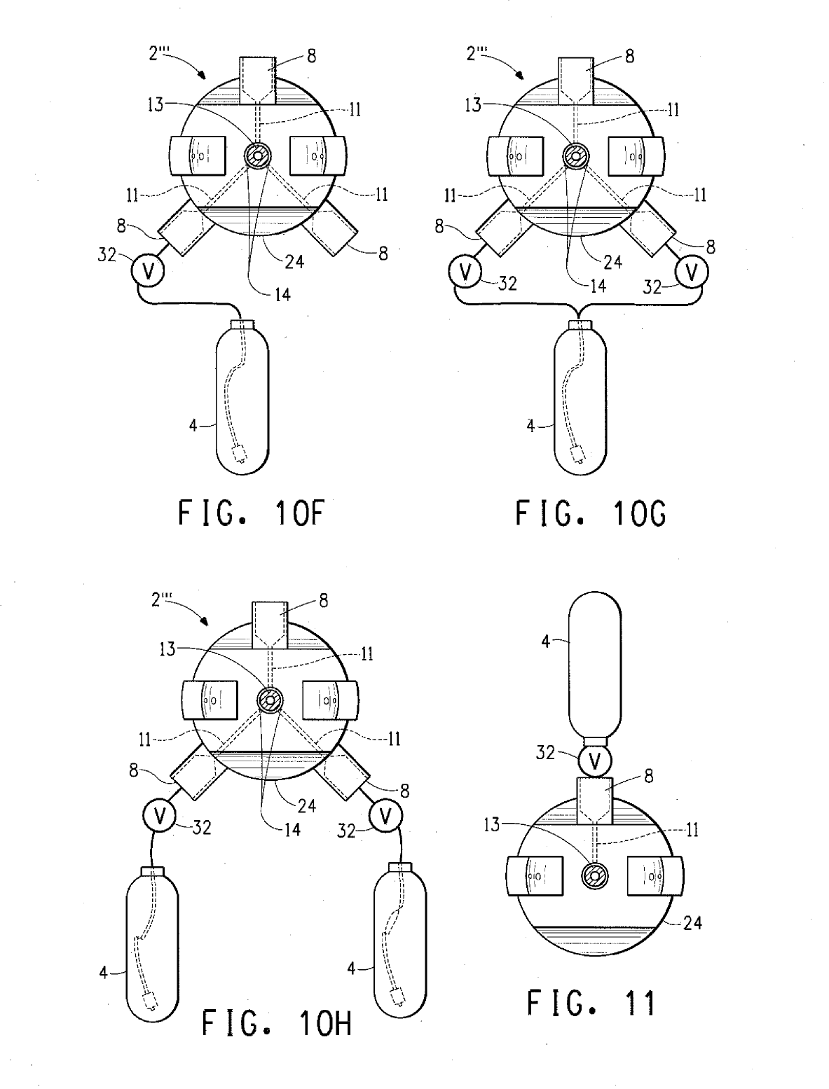

The second coating component can include the catalyst that catalyses the crosslinking reaction between the crosslinkable and the crosslinking components. One example of the second coating component can be a tin catalyst such as dibutyl tin dilaurate: or tertiary amines, such as, triethylenediamine. Another example of the second coating component can be a solution comprises tin catalyst, such as dibutyl tin dilaurate and acetic acid. The second coating component can comprise one or more sub-components stored in separate containers. For example, the aforementioned tin catalyst and the acetic acid that can be stored in separate containers. The one or more sub-components of the second coating component can be siphoned separately such as in the configurations shown in FIG. 9A, 10C, 10E or 10H. The one or more sub-components of the second coating component can be siphoned together such as in the configurations shown in FIG. 10B.

The second coating component can be siphoned from at least one delivery outlet (14) with a siphoning stream selected from the first atomized stream of the first coating component, the stream of the pressurized carrier, or a combination thereof. The delivery outlet is coupled to a second storage container containing said second component, said delivery outlet being transversely positioned at said orifice. Said delivery outlet and said orifice can be positioned at any relative angles or relative positions such that the siphoning can effectively take place. While not wishing to be bound by any particular theory, “siphoning” is believed to occur when the siphoning stream is moving at high speed at the delivery outlet causing negative air pressure around the delivery outlet. Such negative air pressure is believed to cause the second coating component to be conveyed to the delivery outlet. High velocity of the stream of the pressurized carrier and sudden change in air pressure associated with the negative air pressure at the delivery outlet are believed to cause the second coating component to become atomized and mixed into the siphoning stream and the first atomized stream of the first coating component. In this invention, the first and the second coating components can be mixed at a pre-determined mixing ratio to form the coating mixture. The second coating component can also be conveyed to the delivery outlet by gravity or a combination of gravity and siphoning in certain embodiments of configurations disclosed herein.

Both the first and the second coating component can be stored in respective storage containers at atmosphere pressure.

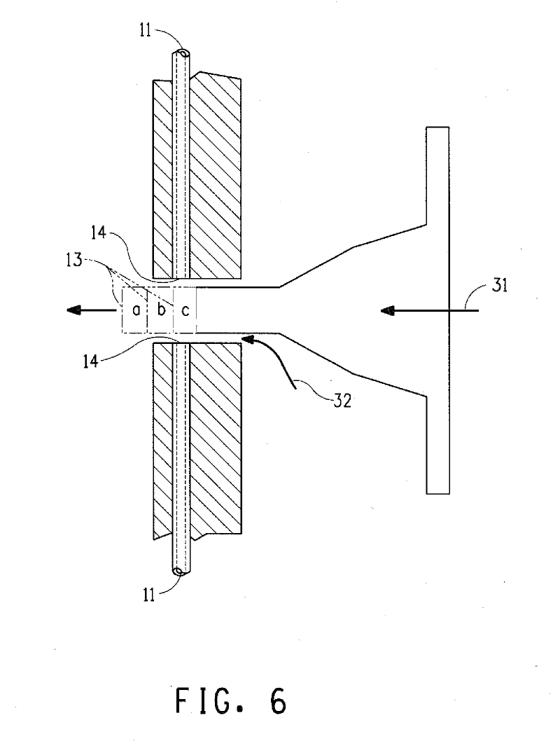

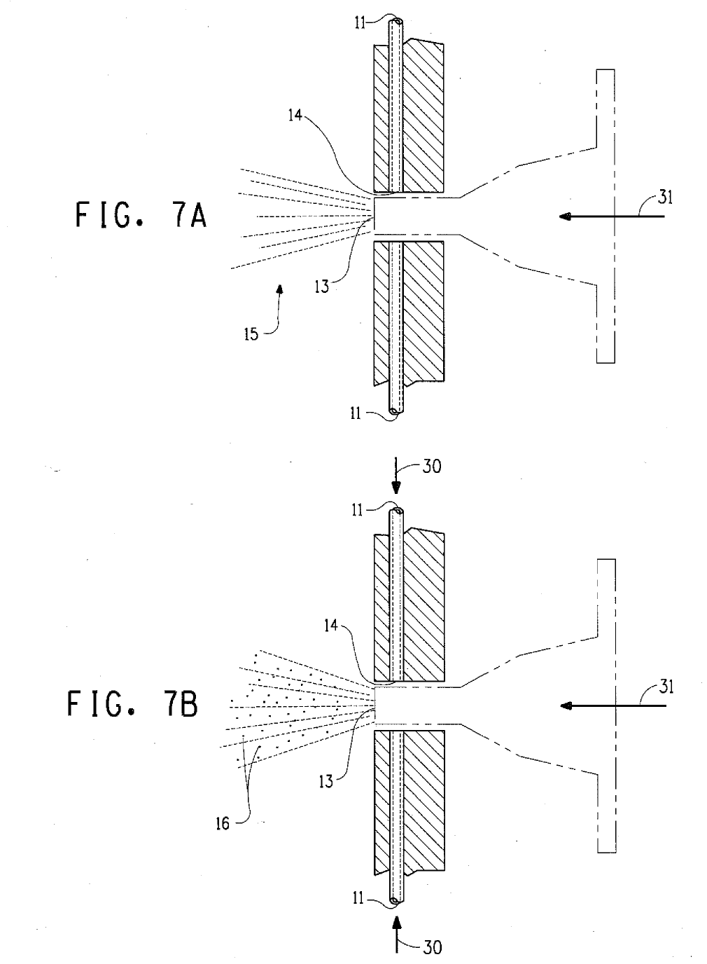

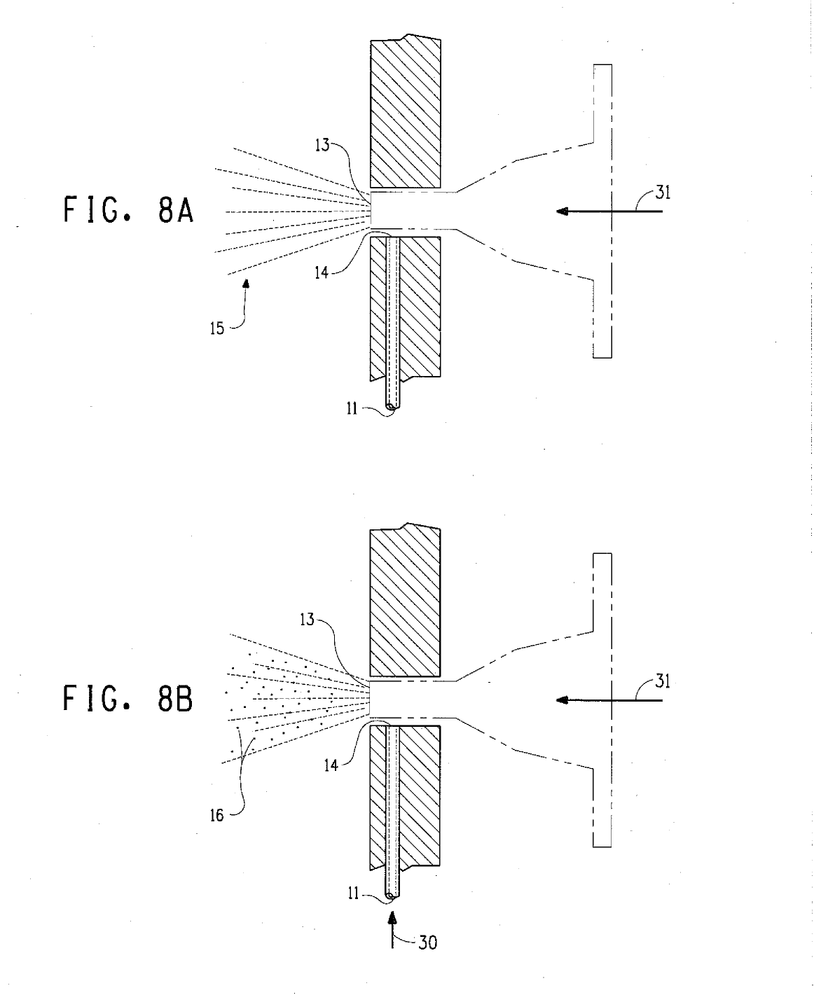

Depending upon the relative position between the orifice (13) and the delivery outlet (14), the second coating component can be siphoned with different siphoning stream. When the orifice is positioned in the position illustrated by the region 13a and 13b in FIG. 6, the second coating component can be siphoned primarily by the pressurized carrier moving at high speed in the direction shown by the arrow (32). FIG. 7 shows examples of a delivery device having two delivery outlets. FIG. 8 shows examples of a delivery device having one delivery outlet. The pressurized carrier then continues to produce atomized first coating component at the orifice (13). The atomized first and second coating component can be mixed to form the coating mixture (16) (FIGS. 7B and 8B). When the orifice is positioned in the position illustrated by the region 13c in FIG. 6, the second coating component can be siphoned primarily by a combination of the pressurized carrier moving at high speed in the direction shown by the arrow (32) and the first atomized stream of the first coating component. If the second coating component is not supplied to the delivery outlet, for example, if a regulatory device (32) is turned off, then only the first coating component is atomized (15) (FIGS. 7A and 8A). Flow of the first coating component is indicated by the arrow (31). Flow of the second coating component is indicated by the arrows (30).

The coating mixture can be applied over a substrate. Typically, a painter can hold the spray gun at a certain distance from the substrate and move it in desired directions so the coating mixture can be sprayed over the substrate forming a layer of the coating composition. This invention can further comprise the step of curing the layer of the coating composition on the substrate to form a coating thereon. This curing step can depend upon the coating composition used. The layer can be cured at ambient temperatures, such as in a range of from 10° C. to 35° C. or at elevate temperatures, such as 35° C. to 180° C., or higher. The curing can also be done by exposing the coating layer to radiation, such as UV light or electron beam, when the coating composition is radiation curable.

The substrate can include wood, plastic, leather, paper, woven and nonwoven fabrics, metal, plaster, cementitious and asphaltic substrates, and substrates that have one or more existing layers of coating thereon. The substrate can be a vehicle, vehicle body, or vehicle body parts.

In another embodiment, the method of this invention can comprise the steps of:
(A) producing a first atomized stream of a first coating component of said coating composition through an orifice of said spray gun with a stream of a pressurized carrier, wherein said first coating component is stored in a first storage container and conveyed through a first inlet of said spray gun to said orifice; producing a second atomized stream of a second coating component of said coating composition, wherein the second atomized stream is produced by siphoning the second coating component with a siphoning stream selected from the first atomized stream of the first coating component, the stream of the pressurized carrier, or a combination thereof, from at least one first delivery outlet of a delivery device coupled to a second storage container containing said second component, said first delivery outlet being transversely positioned at said orifice;
(C) optionally, regulating the supply of the second coating component to said first delivery outlet by coupling a first regulatory device to said first delivery outlet;
(D) producing a subsequent atomized stream of a subsequent component of said coating composition, wherein the subsequent atomized stream is produced by siphoning the subsequent coating component with the siphoning stream from at least one subsequent delivery outlet of the delivery device coupled to a subsequent storage container containing said subsequent component, said subsequent delivery outlet being transversely positioned at said orifice;
(E) optionally, regulating the supply of the subsequent coating component to said subsequent delivery outlet by coupling a subsequent regulatory device to said subsequent delivery outlet;
(F) intermixing the first atomized stream, the second atomized stream and the subsequent atomized stream to form a coating mixture; and
(G) applying the coating mixture on the substrate to form the layer of said coating composition thereon.

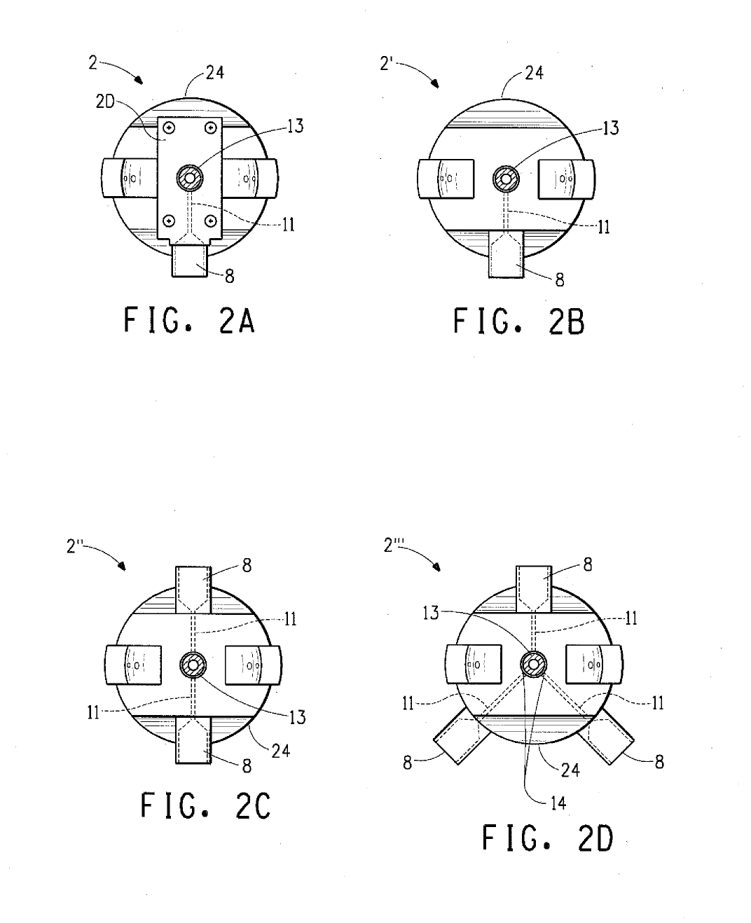

The first delivery outlet and the subsequent delivery outlet can be separate delivery outlets or combined into a single delivery outlet. FIGS. 2C, 2D, 4, 5, 6, 7, 9A show some examples of separate delivery outlets. FIG. 9B show one example where two delivery outlets can be combined into a single delivery outlet. Based on disclosure of this invention herein, more delivery outlets and/or different placement and positioning of delivery outlets can be configured by those skilled in the art without departing from the scope and spirit of this invention.

All the components, including the first and the second coating component, and any subsequent component can be stored in respective storage containers at atmosphere pressure.

One advantage of this invention is that said atomized first coating component, said atomized second coating component, and any subsequent coating component if present, can be mixed at a pre-determined mixing ratio to form said coating mixture without the need for complex controls such as those described in aforementioned U.S. Pat. No. 4,824,017. The pre-determined mixing ratio can be determined by modulating or selecting the size of the delivery outlet (14), the size of connecting path (11), or by providing a regulatory device such as a flow rate controller functionally coupled to said delivery device, or a combination thereof. It can be configured that one regulatory device can regulate the flow rate of one or more delivery outlets. Mixing ratio can also be controlled by modulating the viscosity of the first, the second or both the first and the second coating components. In one example, viscosity of the second coating component can be increased to reduce the amount being siphoned into the coating mixture. In another example, viscosity of the second coating component can be reduced to increase the amount being siphoned into the coating mixture. Similarly, viscosity of the first coating component can be reduced or increased as needed to achieve a desired mixing ratio.

The applicants unexpectedly discovered that using the method of this invention, mixing ratio can be constant within a wide range of pressures of the pressurized carrier ranging from 20-80 pounds per square inch gauge (psig), in one example, pressure of the pressurized carrier can be in a range of from 25 to 70 psig. In another example, pressure of the pressurized carrier can be in a range of from 28 to 65 psig. In yet another example, pressure of the pressurized carrier can be in a range of from 30 to 60 psig.

In one example, the mixing ratio can be determined by selecting different sizes of the diameter of the delivery outlet. Coating mixtures formed by using different sizes of the outlets can be sprayed onto suitable substrates. Properties of the coating layers formed thereon can be measured. Based on the property measurement, a suitable size or a range of suitable sizes of the delivery outlets can be selected. In another example, the mixing ratio can be determined by selecting different size of diameter of the connection path.

The regulatory device can be selected from a mechanical flow restrictor, an electric flow restrictor, a pressure controlled flow restrictor, an actuated pneumatic flow restrictor, or a combination thereof. Examples of a mechanical flow restrictor can include a tube with a pre-determined flow pass diameter that is coupled to the delivery outlet, or a mechanical valve that can control flow passage. Examples of an electronic flow restrictor can include electrical valves or a electrical valve actuator. A pressure controlled flow restrictor can be any mechanical or electric controllers that can control flow based on pressure.

A flow rate controller, such as a valve or a commercial inline flow controller can be coupled to the delivery outlet to adjust the flow of the second coating component therefore affecting mixing ratio. A flow rate controller can also be a small insert that is placed inside a connection path of a tubing connected to a connection path that is coupled to the delivery outlet. Such an insert can effectively reduce the size of the connection path or the tubing therefore reduces the flow of the second coating component.

Selection of sizes and the use of flow rate controller can be combined. For example, a size within a suitable range of the delivery outlet can be selected and a valve can be coupled to the delivery outlet so the mixing ratio can be fine tuned. Any flow rate controller that can be coupled to the delivery outlet can be suitable for this invention.

A regulatory device can be coupled to a delivery outlet at any places that can effectively regulate flow to that delivery outlet. The regulatory device can be coupled at an intake coupling or be placed in a connection path connecting to that particular delivery outlet. The regulatory device can also be placed at any place along a tubing that delivers the second or the subsequent coating component from its storage container to the intake coupling of the delivery device.

Another advantage of this invention is to have fast curing while maintaining extended pot life. In conventional process, short pot life is a challenge when a coating composition is formulated to be fast curing since all components are mixed together in a pot mix and curing reaction starts immediately upon mixing. In this invention, the coasting composition can have extended pot life before spraying since one or more component for cuing, such as a catalyst, is not mixed together. The coating composition can then be cured rapidly after spraying since the second coating component, such as a catalyst, is mixed after atomization during spraying.

Yet another advantage of this invention is that some aspects of spraying or the coating property can be modified in an on-demand fashion. For example, curing time of a coating composition can be modulated by modifying the amount of a catalyst mixed into the coating composition during spraying. It can be done by tuning the regulatory device while spraying.

This invention is also be directed to a coating layer and a coated substrate produced by the method of this invention.

This invention is further directed to a system for producing a layer of a coating composition on a substrate using the method of this invention. The system can comprise:
(A) a spray gun comprising a spray gun body (1), one or more inlets, a nozzle assembly (2) including an orifice (13) and an air cap (24); and
(B) a delivery device comprising:
   (i) at least one delivery outlet (14), wherein said delivery outlet being transversely positioned at said orifice (13);
   (ii) at least one intake coupling (8); and
   (iii) at least one connection path (11) connecting said intake coupling (8) and said delivery outlet (14), wherein said delivery outlet is coupled through said connection path and said intake coupling to a storage container (4) containing a second coating component;
(C) optionally, a regulatory device (32) coupled to said delivery outlet regulating the supply of the second coating component to said delivery outlet;
wherein a first atomized stream of a first coating component of said coating composition is produced at said orifice (13) with a stream of a pressurized carrier, wherein said first coating component is stored in a first storage container and conveyed through a first inlet of said spray gun to said orifice;
wherein a second atomized stream of a second coating component of said coating composition is produced by siphoning the second coating component with a siphoning stream selected from the first atomized stream of the first coating component, the stream of the pressurized carrier, or a combination thereof, from said delivery outlet (14) coupled to a second storage container containing said second component.

The delivery outlet (14), the intake coupling (8), and the connection path (11) can be constructed as an add-on device affixed to the air cap of the spray gun, or can be constructed into the air cap of said spray gun. Representative examples of the add-on device can include the ones shown in FIGS. 2A, 3, 4, 9A and 9B. The add-on device can be affixed to the air cap using conventional means such as one or more screws, clips, clamps, adhesives, latches, or a combination thereof. Examples of the delivery device constructed into the air cap can include those shown in FIGS. 2B, 2C and 2D. The delivery device can comprise one delivery outlet, such as those shown in FIGS. 2A, 2B and 3. The delivery device can also comprise two or more delivery outlets, such as those shown in FIGS. 2C, 2D, 4, and 9A. Two or more delivery outlets can be combined into a single delivery outlet, such as the one shown in FIG. 9B.

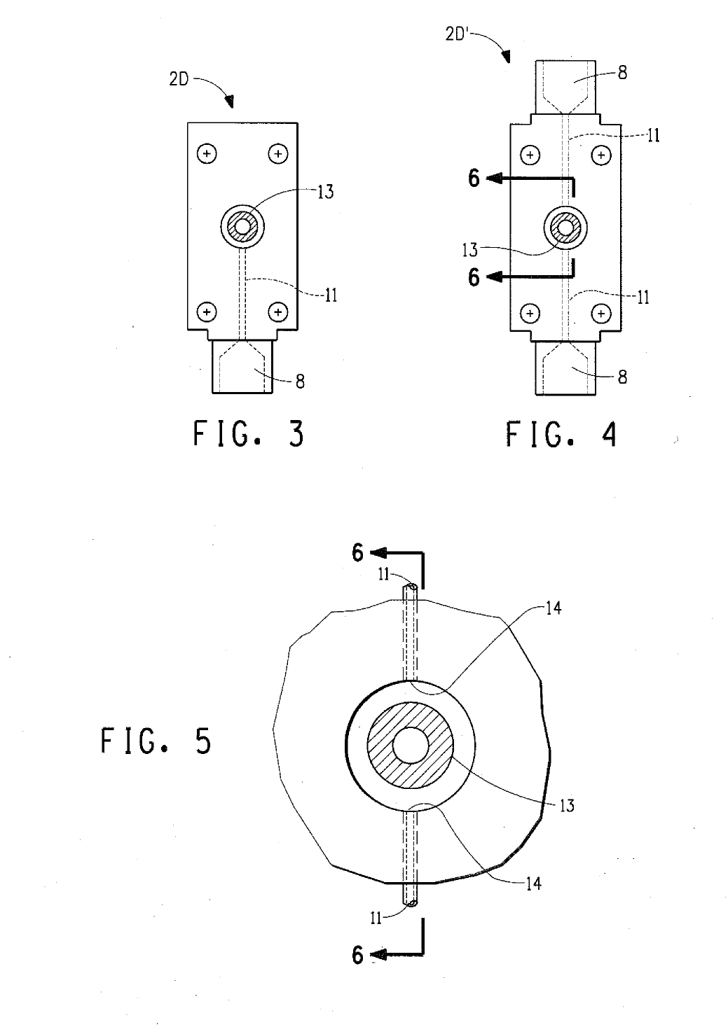

Representative configurations of the add-on device (2D) can be shown in FIGS. 2A, 3, 4, 9A, and 9B. The system can have a single delivery outlet (14), such as shown in FIGS. 2A, 3, and 9B; or two or more delivery outlets (14) as shown in FIGS. 4 and 9A. Based on descriptions disclosed herein, those skilled in the art can make modifications and re-configurations so the add-on device can be used with other spray guns, nozzle assemblies, air caps, or a combination thereof.

FIG. 5 shows an enlarged frontal view of the orifice (13) and two of the delivery outlets (14), FIG. 6 shows a cross sectional side view of the delivery device indicating the relative positions of two of the delivery outlets (14) and the orifice (13) wherein each of the delivery outlets (14) is transversely positioned at said orifice (13). As described before, depending upon the relative position between the orifice (13) and the delivery outlet (14), the second (or a subsequent) coating component can be siphoned with different siphoning stream. Although perpendicular relative position is shown in the Figures and examples of this disclosure, the delivery outlet and the orifice can be positioned in any relative positions such that siphoning can effectively take place.

The system of this invention can be configured to siphon a third or a subsequent component. A delivery device of this invention can be configured to have multiple intake couplings (8), multiple connection paths (11) or multiple delivery outlets (14) as shown in representative examples in FIGS. 2C, 2D, 4, 9A, and 9B. Other examples of configurations are shown in FIGS. 10A through 10H. In another representative configuration, two or more connection paths can be combined at a point so the connection paths are connected to a single delivery outlet (14), which can be transversely positioned at the orifice (13). One example is shown in FIG. 98.

The one or more intake couplings (8) can be configured to couple with one or more individual storage containers (4) through direct coupling, such as plug on or screwed on, or via connection means such as fixed or flexible tubing. Additional hardware such as one or more “Y” shaped connectors can also be used. Examples of suitable configurations are shown in FIG. 10: (A) a delivery device having a single delivery outlet/intake coupling that is coupled to a single container; (B) a delivery device having a single intake coupling that is coupled to two individual containers; (C) a delivery device having two outlets/intake couplings that are coupled to two individual containers (shown) or a single container (not shown); (D)-(H) a delivery device having multiple outlets and intake couplings that only some of them are coupled to one or more containers, wherein the other intake(s) can be closed. When a delivery device has two or more intake couplings and only one of them is coupled to a container, it is preferred to close the un-coupled intake couplings via conventional means, such as a cap, a plug, or a valve. Optionally, one or more regulatory devices (32) that controls flow rate, such as a valve, an insert, a clamp, or a commercial inline flow controller can be positioned and configured to control flow rate of one or more components at one or more positions. The regulatory device can be selected from a mechanical flow restrictor, an electric flow restrictor, a pressure controlled flow restrictor, or a combination thereof. Those skilled in the art can design or modify configurations based on descriptions of this invention disclosed herein without departing from the spirit and scope of this invention.

FIG. 11 shows an example of another representative configuration. In this example, the container (4) can be connected at the top of the intake coupling (8) via conventional connections, such as a screw connection or a plug-in connection. A regulatory device (32), such as a valve, can be placed in the path connecting the container (4) and the intake coupling (8). In one example, the regulatory device (32) is a valve has two coupling ends: one coupled to the intake coupling (8) and the other coupled to the container (4).

In another example, the regulatory device (32) is a valve built in the container that can be coupled to the intake coupling (8). In yet another example, the regulatory device (32) is a valve built in the intake coupling (8) that can be coupled to the container (4). The regulatory device (32) can be turned on or off manually, or by connecting to the trigger (22) mechanically or electronically. It is preferred that the regulatory device (32) can be turned off when the spray gun is not spraying to prevent leaking of the contents in the container (4) and can be turned on to allow the content in the container (4) to flow to the delivery outlet (14).

The storage container (4) containing the second or a subsequent coating component can be a flexible container, such as a plastic bag; a fixed-shape container, such as a canister made of metal or hard plastic; or a flexible inner container inside a fixed-shape container, such as a flexible plastic bag placed inside a fixed-shape metal container. A flexible container that can be collapsed easily is preferred. The flexible container can be a collapsible liner that can be sealed and used directly or be placed inside a fixed shape container. The storage container can be transparent or have a transparent window so the level of the content in the container can be readily visible. The storage container can have an indicator to indicate the level of the contents in the container. The storage container can be disposable or reusable. The storage container can be coupled to an intake coupling (8) which is connected to the delivery outlet (14) through a connection path (11). The storage container can be coupled to the intake coupling (8) via conventional means, such as a clip, a clamp, a set of matching screw tracks, or a plug-in. In one example, the storage container comprises a tube that can be plugged into the intake coupling (8). In another example, the storage container is screwed onto the intake coupling (8) via matching screw tracks. In yet another example, the storage container is plugged into the intake coupling (8) and secured by an additional fastener. The storage container can further have a unidirectional flow limiter (26) to eliminate back flow, wherein said unidirectional flow limiter can only allow the content to flow in one direction, such as only from the container to the delivery outlet. Any back flow can be stopped by the directional flow limiter to avoid potential contamination. For a fixed-shape container, ventilation can be provided so the contents in the container can be maintained at atmosphere pressure.

Although coating compositions with multiple coating components are specifically described here, this invention can also be used for a composition having multiple components that need to be mixed to form a mixed composition. With this invention, a first component of the composition can be atomized by a spray device and a second or a subsequent component of the composition can be siphoned into the atomized first component to form the mixed composition.

This invention is further directed to a system for producing a mixed composition comprising two or more components. Said system can comprise:
(A) a spray gun comprising a spray gun body (1), one or more inlets, a nozzle assembly (2) including an orifice (13) and an air cap (24); and
(B) a delivery device comprising:
   (i) at least one delivery outlet (14), wherein said delivery outlet being transversely positioned at said orifice (13);
   (ii) at least one intake coupling (8); and
   (iii) at least one connection path (11) connecting said intake coupling (8) and said delivery outlet (4), wherein said delivery outlet is coupled through said connection path and said intake coupling to a storage container (4) containing a second coating component;
(C) optionally, a regulatory device (32) coupled to said delivery outlet regulating the supply of the second coating component to said delivery outlet;
wherein a first atomized stream of a first component of said mixed composition is produced at said orifice (13) with a stream of a pressurized carrier, wherein said first component is stored in a first storage container (3) and conveyed through a first inlet of said spray gun to said orifice (13);
wherein a second atomized stream of a second component of said mixed composition is produced by siphoning the second component with a siphoning stream selected from the first atomized stream of the first component, the stream of the pressurized carrier, or a combination thereof, from said delivery outlet (14) coupled to a second storage container (4) containing said second component.

In the system described above, said stream of atomized first component can be produced by a compressed carrier selected from compressed air, compressed gas, compressed gas mixture, or a combination thereof.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

Viscosity can be determined by using Zahn cup #2 viscosity measurements in second. Pot life in following examples is defined by the length of time required to double viscosity of the coating composition or the relevant pot mix.

Micro-hardness of the coatings was measured using a Fischerscope hardness tester (model HM100V). The tester was set for maximum force of 100 mN ramped in series of 50, 1 second steps. The hardness was recorded in N/mm.

Wavescan was measured using a Wavescan instrument from Byk-ChemieBoth short (s) and long (L) values were recorded.

Cotton free test: after baking the coating, the panel was tested by dropping a cotton ball from a distance of 1 inch. The cotton ball was left on the coating for 2 minutes and then the panel was inverted. If the cotton ball falls off the panel, without leaving any residue, it is said to be cotton free.

### Coating Examples 1-3

DuPont ChromaClear® G2-7779S™, under respective registered or unregistered trademarks, was mixed with an activator 7775S (both available from E. I. duPont de Nemours and Company, Wilmington, USA) according to manufacturer's directions to form a first coating mix, also referred to as a first coating component. The first coating component was placed in the main storage container (also referred to as a first storage container) of a gravity spray gun.

Various catalyst solutions were prepared according to Table 1. Each was used as a second coating component and was placed in a second container of the spray gun.

Mixing ratio of the first coating component/the second coating component was controlled at about 13/1 by selecting a suitable size of a connection tubing connecting the second container and the delivery outlet of the delivery device.

The clearcoats prepared above were sprayed over Uniprime (ED-5000, cold-rolled steel (04X12X032)B952 P60 DIW unpolish Ecoat POWERCRON 590 from ACT Laboratories, Hillsdale, Mich.) to a film thickness of 2.3 to 2.6 mils. The coatings were baked for 5 min or 10 min at 60° C. as indicated.

TABLE 1
Coating Properties.

| | | Example 2 | Example 3 |
|---|---|---|---|
| | Example 1 | 0.125% | 0.0625% |
| | 0.125% | DBTDL and | DBTDL, and |
| | DBTDL in | 2% acetic acid | 0.5% acetic acid |
| | ethyl acetate | in ethyl acetate | in ethyl acetate |
| Cotton free after 5 min | No | No | Yes |
| at 60° C. | | | |
| Cotton free | Yes | Yes | Yes |
| after 10 min. at 60° C. | | | |
| Wavescan L 1 day | 3.8 | 2.0 | 1.7 |
| after baking for 5 min | | | |
| Wavescan s 1 day | 12.0 | 7.9 | 4.3 |
| after baking 5 min | | | |
| Fischer Micro- | 5.0 | 5.0 | 4.0 |
| hardness 4 hrs after | | | |
| 5 min bake (N/mm) | | | |
| Fischer Micro- | 5.0 | 4.0 | 4.0 |
| hardness 4 hours | | | |
| after 10 min bake | | | |
| (N/mm) | | | |

DBTDL = dibutyltin dilaurate.

### Examples 4-6

DuPont ChromaClear® G2-7779S™ is placed in a first storage container of a gravity spray gun as a first coating component. The activator 7775S is placed in a second storage container of the spray gun as a second coating component. Mixing ratio between the first and the second coating component is set at about 12/3.

In Example 4, 0.125% of DBTDL as in Example 1 is used as a third coating component and placed in a third storage container. Mixing ratio of the first/the second/the third coating components is set as 12/3/1.

In Example 5, 0.125% of DBTDL and 2% acetic acid as in Example 2 is used as a third coating component and placed in a third storage container. Mixing ratio of the first/the second/the third coating components is set as 12/3/1.

In Example 6, 0.0625% of DBTDL and 0.5% acetic acid as in Example 3 is used as a third coating component and placed in a third storage container. Mixing ratio of the first/the second/the third coating components is set as 12/3/1.

Coatings are sprayed over substrates as described in Examples 1-3.

### Example 7

DuPont ChromaClear® G2-7779S™ is mixed with an activator 7775S as in Example 1-3 and is placed in the first storage container of a gravity spray gun as a first coating component.

DBTDL at the concentration of 0.25% is used as a second coating component and placed in a second storage container. Four percent acetic acid in ethyl acetate is used as a third coating component and placed in a third storage container.

A mixing ratio of the first/the second coating component=13/0.5 is used. During spray, a valve controlling the flow of the third coating component (4% acetic acid) is initially turned on so acetic acid is mixed into the coating mixture. The valve is then slowly turned off during spray so decreasing amount of acetic acid is mixed into the coating mixture. Coating is sprayed over substrates as described in Examples 1-3. Acetic acid is believed to modulate the activity of the catalyst DBTDL. With less acetic acid, the activity of DBTDL is higher so the coating can be cured faster. With decreasing amount of acetic acid during spray, the entire coating layer can cure evenly.

What is claimed is:

1. A system for producing a layer of a coating composition on a substrate, said coating composition comprises two or more coating components, said system comprising:
(A) a spray gun comprising a spray gun body (1), one or inlets, a nozzle assembly (2) including an orifice (13) and an air cap (24); and
(B) a delivery device comprising:
(i) at least one delivery outlet (14), wherein said delivery outlet being transversely positioned at said orifice (13);
(ii) at least one intake coupling (8); and
(iii) at least one connection path (11) connecting said intake coupling (8) and said delivery outlet (14), wherein said delivery outlet is coupled through said connection path (11) and said intake coupling (8) to a second storage container (4) containing a second coating component;
(C) optionally, a regulatory device (32) coupled to said delivery outlet regulating the supply of the second coating component to said delivery outlet;
wherein a first atomized stream of a first coating component of said coating composition is produced at said orifice (13) with a stream of a pressurized carrier, wherein said first coating component is stored in a first storage container (3) and conveyed through a first inlet of said spray gun to said orifice (13);
wherein a second atomized stream of the second coating component of said coating composition is produced by siphoning the second coating component with a siphoning stream selected from the first atomized stream of the first coating component, the stream of the pressurized carrier, or a combination thereof, from said delivery outlet (14) coupled to the second storage container (4) containing said second coating component.

2. The system of claim 1, wherein said delivery outlet, said intake coupling, and said connection path are constructed as an add-on device affixed to the air cap of said spray gun.

3. The system of claim 1, wherein said delivery outlet, said intake coupling, and said connection path are constructed into the air cap of said spray gun.

4. The system of claim 1, wherein said storage container (4) is coupled to the intake coupling (8) via the regulatory device (32).

5. The system of claim 1, wherein said delivery device comprises two or more delivery outlets.

6. The system of claim 1, wherein said delivery device comprises two or more intake couplings.

7. The system of claim 1, wherein said regulatory device is selected from a mechanical flow restrictor, an electric flow restrictor, a pressure controlled flow restrictor, or a combination thereof.

8. A system for producing a mixed composition comprising two or more components, said system comprising:
(A) a spray device for producing a first atomized stream of a first component of said mixed composition through an orifice (13) of said spray device; and
(B) a delivery device comprising:
(i) at least one delivery outlet, wherein said delivery outlet being transversely positioned at said orifice (13);
(ii) at least one intake coupling (8); and
(iii) at least one connection path (11) connecting said intake coupling (8) and said delivery outlet (14), wherein said delivery outlet is coupled through said connection path (11) and said intake coupling (8) to a second storage container (4) containing a second component;
(C) optionally, a regulatory device (32) coupled to said delivery outlet regulating the supply of the second component;
wherein a first atomized stream of a first component of said mixed composition is produced at said orifice (13) with a stream of a pressurized carrier, wherein said first component is stored in a first storage container (3) and conveyed through a first inlet of said spray gun to said orifice (13);
wherein a second atomized stream of the second component of said mixed composition is produced by siphoning the second component with a siphoning stream selected from the first atomized stream of the first component, the stream of the pressurized carrier, or a combination thereof, from said delivery outlet (14) coupled to the second storage container (4) containing said second component.

9. The system of claim 8, wherein said stream of atomized first component is produced by a compressed carrier selected from compressed air, compressed gas, compressed gas mixture, or a combination thereof.
